(19) United States
(12) Patent Application Publication
(10) Pub. No.: US 2025/0139209 A1
(43) Pub. Date: May 1, 2025

(54) MITIGATING FRAUDULENT ACTIVITIES RESULTING FROM SIM SWAPPING

(71) Applicant: Microsoft Technology Licensing, LLC, Redmond, WA (US)

(72) Inventors: Amer Aref HASSAN, Kirkland, WA (US); Eric Edmond THOMASIAN, Los Angeles, CA (US); Shaun DUNNING, Redmond, WA (US)

(21) Appl. No.: 18/385,821

(22) Filed: Oct. 31, 2023

(51) Int. Cl. G06F 21/31

(52) U.S. Cl. CPC G06F 21/31

(57) ABSTRACT

A system and method for preventing fraudulent access to user accounts and user data resulting from SIM swapping are disclosed. A server providing a unified communications service receives a message containing an authentication code addressed to a subscriber mobile device. The server determines a threat level by analyzing recent subscriber login data for suspicious patterns. If the threat score exceeds a threshold, the server divides the authentication code into two portions before sending. One portion is transmitted via regular SMS to the native messaging app on the subscriber's device. The other portion is sent through a subscriber messaging client of the unified communications service. This dual channel delivery allows legitimate users to receive the full code while preventing unauthorized users who may have swapped the subscriber's SIM card. Additional threat detection involves monitoring the status of the native messaging app and notifying subscribers of anomalies indicating potential SIM swapping.

### TECHNICAL FIELD

The present application relates to the technical field of data security in online communications. More specifically, the present application involves a technique for mitigating fraudulent activity resulting from a malicious actor swapping or “jacking” a Subscriber Identify Module (SIM), including an embedded SIM (eSIM).

### BACKGROUND

A SIM card is a small, removable card that is critical for operating and identifying a mobile device on a cellular network, often referred to as a mobile network. The SIM card contains the International Mobile Subscriber Identity (IMSI), which uniquely identifies the user on the mobile network. It also stores authentication keys for securing communications, and other configuration data like the Service Provider Name (SPN) for a mobile network operator, also referred to as a mobile network provider.

An eSIM serves the same overall functions as a traditional physical SIM card, but in an integrated digital form. The eSIM is typically soldered directly onto a device's motherboard rather than being a removable card. Like a SIM card, the eSIM stores the IMSI and authentication keys needed to connect to a mobile network. However, the eSIM approach saves physical space and eliminates the need for a SIM card slot on the mobile device. Additionally, eSIMs can be reprogrammed remotely to change carriers or plans without swapping physical SIM cards. This makes switching between mobile network providers easier, especially for devices requiring frequent network changes.

Both SIM cards and eSIMs play essential security roles within mobile devices. They contain unique identifiers that authenticate the device to the mobile network, preventing unauthorized access. The SIM/eSIM also store encryption keys for securing communications over the mobile network. Additionally, they associate the device with the user's phone number, which is necessary for making and receiving calls and messages. If a malicious actor compromises the SIM/eSIM, they could impersonate the user's phone number and gain access to user accounts and user data secured by SMS-based two-factor authentication. Therefore, the SIM/eSIM are critical for establishing trusted device identity and protecting the mobile device and linked accounts from fraudulent access.

### BRIEF DESCRIPTION OF THE DRAWINGS

Embodiments of the present invention are illustrated by way of example and not limitation in the figures of the accompanying drawings, in which:

FIG. 1 is a diagram illustrating an example of how a malicious actor may facilitate a fraudulent activity, subsequent to SIM jacking another user's SIM or eSIM.

FIG. 2 is a diagram illustrating a network environment, consistent with which an embodiment of the invention may be deployed, wherein the network environment includes a cloud-based mobile network operator (MNO) integrated with a provider of Unified Communications as a Service (UCaaS), or simply unified communications service.

FIG. 3 is a diagram illustrating a more detailed view of the unified communications service, consistent with some embodiments.

FIG. 4A is a diagram illustrating the method operations of a method, performed by a unified communications service, to securely communicate an SMS message containing an authentication code, consistent with some embodiments.

FIG. 4B is a diagram illustrating examples of the user interfaces of different messaging applications, when an authentication code is communicated in a manner consistent with the method illustrated and described in connection with FIG. 4A.

FIG. 5 is a block diagram illustrating a software architecture, which can be installed on any of a variety of computing devices to perform methods consistent with those described herein.

FIG. 6 is a diagrammatic representation of a machine in the form of a computer system (e.g., a server computer) within which a set of instructions may be executed for causing the machine to perform any one or more of the methodologies discussed herein, according to an example embodiment.

### DETAILED DESCRIPTION

Described herein are methods and systems for preventing fraudulent access to user accounts and user data resulting from SIM swapping and SIM jacking attacks. In the following description, numerous specific details are set forth regarding exemplary embodiments of the present invention in order to provide a thorough understanding of the various aspects of different embodiments. However, one skilled in the art will understand that the present invention may be practiced without utilizing all of the specific details presented in this description. Some well-known structures and functions may not be shown or described to avoid obscuring the disclosure.

SIM jacking and SIM swapping are types of fraud where a malicious actor illegally ports a mobile device phone number of a subscriber to a mobile network operator to a SIM card or eSIM under their control. This unauthorized transfer allows the malicious actor to intercept calls and messages (e.g., text message and SMS messages) intended for the victim's device. The malicious actor can also impersonate the victim by making outbound calls and sending messages from the hijacked number. By posing as the victim, the malicious actor can interact with customer service agents or spread disinformation. Furthermore, authentication codes, including one-time passcodes sent via SMS, can be exploited by the malicious actor to bypass multi-factor authentication and access the victim's online accounts, enabling identity theft and financial fraud. Through SIM jacking and swapping, the malicious actor can fully impersonate the victim's phone identity.

The consequences of SIM jacking and swapping attacks can be severe. By gaining control of the victim's phone number, the malicious actor can potentially reset account passwords and bypass two-factor authentication secured by SMS passcodes. This grants the malicious actor access to the victim's online accounts, finances, and personal data. Beyond enabling fraud and identity theft, SIM swapping also jeopardizes the confidentiality of the victim's phone communications. In summary, SIM jacking and swapping represent serious threats to individuals privacy, accounts, and assets accessed through mobile devices.

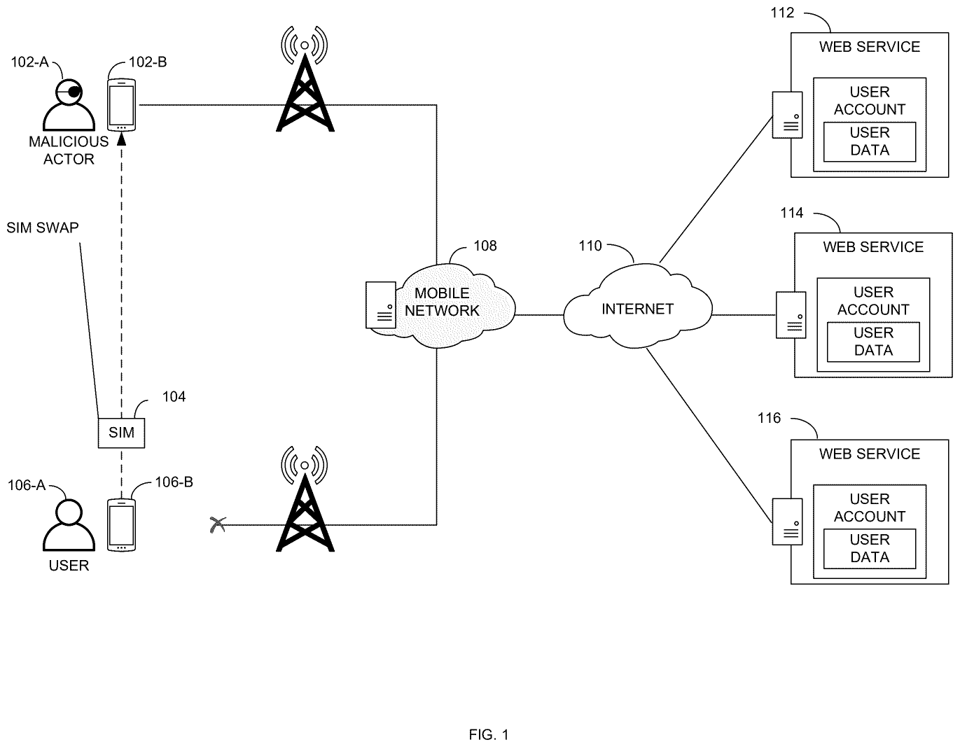

FIG. 1 is a diagram illustrating an example of how a malicious actor 102-A may facilitate fraudulent activity, subsequent to SIM jacking another user's SIM or eSIM 104. As shown in FIG. 1 a malicious actor 102-A has swapped the SIM 104 of a user 106-A and is now impersonating the user's phone number on his or her mobile device 102-B. There are numerous ways that a malicious actor may hijack, swap or steal the SIM (including an eSIM) of another user, such as physically stealing the SIM card, utilizing social engineering to convince a mobile network operator to reprogram the victim's eSIM, or intercepting a QR code or unique identifier for activating an eSIM.

Meanwhile, the user's mobile device 106-B no longer connects to the mobile network 108, as all communications directed to the user's phone number are now routed to the malicious actor's mobile device 102-B. The malicious actor 102-A has effectively hijacked the phone identity of the user 106-A. With control of the user's phone number, the malicious actor 102-A can now intercept any calls and messages intended for the user's device 106-B. This includes SMS messages that may include authentication codes, such as one-time passcodes used in multi-factor authentication. For example, many online services use SMS-based two-factor authentication for added security. When the user 106-A tries to log into a bank account, the web service 112 of the bank's website may send an SMS message with a one-time passcode to a mobile number associated with the SIM 104 of the user's mobile device 106-B. But since the malicious actor now controls the user's phone number, that passcode is sent over the Internet 110, and then to the mobile device 102-B of the malicious actor 102-A. If the malicious actor 102-A can combine this passcode with additional login credentials obtained elsewhere, such as the user's username or password, they may be able to fully impersonate the user 106-A and log in as the user to access his or her bank account, and other user data.

Similarly, other web services 114 and 116 like social media accounts, email services, and cryptocurrency exchanges often rely on SMS passcodes for two-factor authentication. By hijacking the user's SIM, the malicious actor 102-A (now an attacker) can circumvent these security measures and gain entry to the user's many online accounts. The malicious actor 102-A may proceed to steal funds, data, and personal information from the victim. This illustrates the gravity of the SIM swapping threat.

SIM swapping creates a variety of technical problems. Specifically, one problem is that current mobile communication protocols and authentication techniques do not provide a technical means for the sender of a message to reliably determine whether the receiving device has experienced an unauthorized SIM swap. When sending a message to a mobile number, the sender transmits it via standard protocols without any ability to technically validate the authenticity of the receiving SIM card. Even if the message contains sensitive authentication codes, there are no technical safeguards in place for the sender to detect if a different physical SIM card has been swapped into the receiving device unbeknownst to the intended user. It is a purely technical limitation of existing mobile communication systems and authentication protocols that prevents message senders, such as servers sending authentication codes, from technically discerning whether a SIM swap has occurred prior to transmitting sensitive messages.

Embodiments of the present invention provide a technical solution to this technical problem and others. Consistent with some embodiments, to prevent fraudulent access to user accounts and user data, certain messages addressed to subscribers of a unified communications service are selectively modified or redirected when there is suspicion of SIM card tampering. For example, with some embodiments, a server computer of the unified communications service receives a text message (e.g., SMS message) containing an authentication code. In this instance, the message is addressed to a phone number associated with a SIM of a user who is a subscriber of the unified communications service. The server checks for signals of SIM card tampering. For example, the server may identify a first login at a first location and time and identify a second login at a second location and time, where the second time is within a specified period of the first time. The server can then determine the distance between the first and second locations and assess whether it would be feasible for the user to physically travel that distance within the specified time period between the logins. If it is deemed impractical for the user to cover that distance in the elapsed time, this may increase a threat score for the user. Additionally, the threat score may be increased if the location of the second login is known to historically have high levels of fraudulent activity associated with it.

In cases where the threat level seems high-that is, the threat level exceeds or transgresses a predetermine threshold—the server divides the authentication code into two portions before delivering it. One portion of the code is sent via regular SMS to the native text messaging application on the user's mobile device. The other portion is transmitted to the user through the unified communications service, such as via an email, a messaging application, a chat application, or a client phone application. If the user's SIM card has not been compromised, the user will receive the two portions of the authentication code via the two different messaging channels—for example, the native SMS messaging client and, for example, the unified communications messaging client. However, if the user's SIM has been compromised, the first portion of the authentication code will be transmitted to the device of the malicious actor who has swapped the user's SIM, and the second portion of the authentication code will be received by the user via the messaging client of the unified communications service. This has dual benefits. First, the malicious actor is prevented from receiving the entire authentication code. Second, the user will be tipped off to the fact that he or she may have a SIM problem.

In another technique, the server may frequently perform checks on the health status of the native text messaging application. If it detects that the application is non-functional, which may indicate SIM swapping, it can notify the victim of potential fraudulent activity through the unified communications service. The server can also automatically send certain text messages, like those containing authentication codes, directly through the unified communications service rather than SMS. Similarly, the server may only send the SMS message with the authentication code to those specific subscriber devices that have been registered with the unified communications service. This provides enhanced security even for users that have not enabled other multi-factor authentication options. Overall, the various embodiment of the present invention provide a technical solution in the way of effective techniques to detect and prevent unauthorized account access resulting from SIM card tampering. Other aspects and advantages of the various embodiment will be apparent from the description of the several figures that follows.

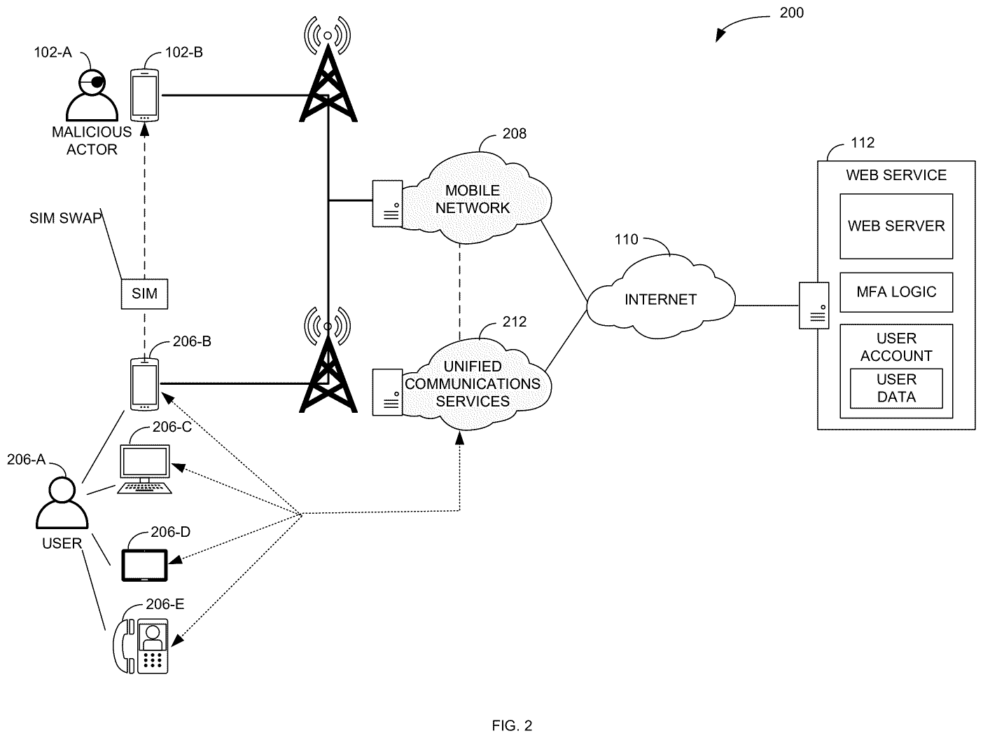

FIG. 2 is a diagram illustrating a network environment 200, consistent with which an embodiment of the invention may be deployed, wherein the network environment includes a mobile network 208 of a mobile network operator integrated with unified communications services, which may be provided by a provider of Unified Communications as a Service (UCaaS). In contrast with FIG. 1, the environment of FIG. 2 includes the unified communications services 212, which is relevant to the techniques described in the present application.

A communication service, such as the unified communications services 212 ties together multiple communication channels and modalities into a single interface accessible across multiple devices. This allows a subscribing user to leverage their mobile device for native SMS messaging via a native SMS application, while also potentially executing a unified communications client application that supports messaging, audio/video calls, file sharing, screen sharing, and more. The unified communications service maintains presence information to track which devices a user is currently logged into. When a call or message comes in, the unified communications service can intelligently route it to the appropriate device(s) based on user presence and preferences.

Critically, by integrating the mobile network 208 of the mobile network operator with the unified communications services 212, the unified communications services has visibility into SMS traffic and can coordinate with the mobile network operator. As described in detail below; this allows the unified communications services 212 to selectively control delivery of certain SMS messages in cases where SIM swapping fraud is suspected. For example, the unified communications services 212 can hold back SMS authentication codes and instead deliver them through the unified communications channel to the user's unified communications clients. Alternatively, an authentication code can be divided into two or more portions, and delivered to different devices. This prevents a malicious actor who has hijacked the user's SIM from receiving sensitive authentication codes unless they also have access to the user's unified communications client application, thereby thwarting unauthorized account access.

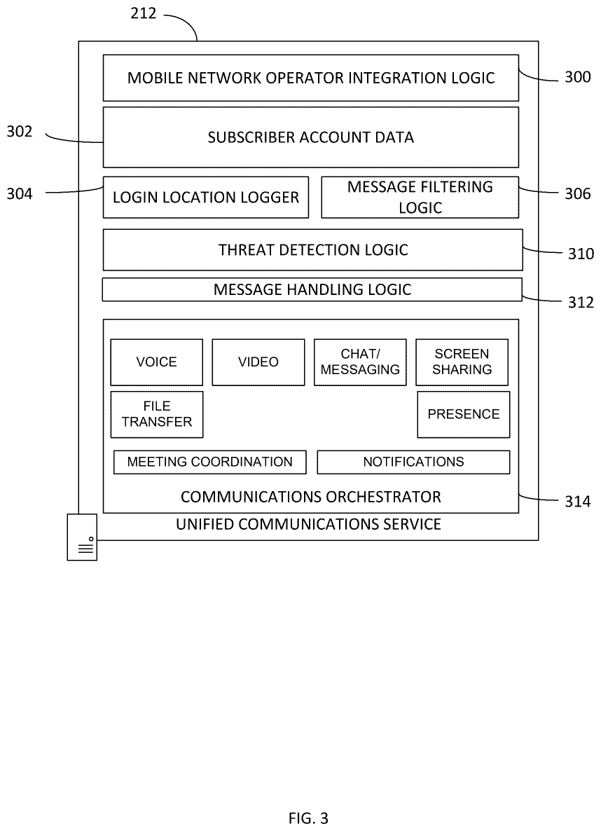

FIG. 3 is a diagram illustrating a more detailed view of the unified communications service 212, consistent with some embodiments. As described previously, the unified communications service 212 is provided via the cloud and integrates with the mobile network 208 of the mobile network operator. FIG. 3 shows example components within the unified communications service 212 that facilitate the techniques related to processing messages and securing against SIM swapping attacks, according to some embodiments.

As shown in FIG. 3, the unified communications service 212 includes mobile network operator integration logic 300. This integration logic 300 enables the unified communications service 212 to interoperate with a mobile network 208 of a mobile network operator. Through this integration, the unified communications service 212 can directly interface with core components of the mobile network 208, including subscriber account databases, messaging infrastructure for SMS and MMS, voice call routing and switching infrastructure, and in some instances, billing systems. This allows the unified communications service 212 to directly provision and manage subscribers' mobile identities and numbers rather than relying on subscribers to bring their own mobile identities. The integration also facilitates enhanced features such as cross-platform messaging and call handovers between the mobile network and unified communications client applications. Additionally, the integration logic 300 allows the unified communication service 212 to implement the techniques described herein, such as interfacing with SMS infrastructure to analyze, divide, block, or redirect messages. The close integration with the mobile network operator enabled by logic 300 is a key enabler for the unified communications service 212 to perform actions related to subscribers' mobile identities and messaging traffic.

The unified communications service 212 further includes storage for subscriber account data 302. This subscriber account data 302 maps subscribers of the unified communications service 212 to their registered mobile devices. In particular, the subscriber account data 302 indicates associations between subscribers and the unique identifiers of the SIMs installed in their registered mobile devices. For example, a single subscriber may have multiple mobile devices, each with a unified communications client application installed and registered with the service 212. The account data 302 will map that subscriber to the IMSI or other unique SIM identifier corresponding to the SIM card in each registered mobile device.

This subscriber account data 302 enables the unified communications service 212 to determine whether a particular mobile device and SIM are registered to a given subscriber. During operation, when the service 212 receives a message such as an SMS intended for a subscriber, it can check the unique SIM identifier against the subscriber account data 302. If the SIM identifier is registered as belonging to the intended subscriber, the service 212 can trust the message is likely legitimate. However, if the SIM identifier does not match any registered to that subscriber, the service 212 can suspect potential SIM swapping fraud, and take measures such as dividing an authentication code before delivering it. The subscriber account data 302 gives the unified communication service 212 greater visibility into the relationships between subscribers and their mobile identities.

The unified communications service 212 also includes a login location logger 304. This component 304 maintains a log of data related to user logins to the service 212 by each subscriber-user. For example, it may record the time, date, location coordinates, IP address, and device type for each login event. This logged data can be leveraged by the threat detection logic 308 when generating a threat score for a subscriber. For instance, the threat logic 308 can analyze the subscriber's recent login history to check for logins from disparate locations that do not seem feasible based on the time elapsed between the logins. This may indicate suspicious activity if the user could not reasonably travel between the login locations in the time period. The login location logger 304 gives the service 212 visibility into subscribers' login patterns, which can be analyzed to detect potential fraud or SIM swapping attacks.

The unified communications service 212 further comprises message filtering logic 306. This filtering logic 306 inspects incoming messages, such as SMS messages, intended for subscribers of the service 212. The filtering logic 306 filters or analyzes messages in a few different ways according to various embodiments. In one embodiment, the filtering logic 306 maintains a “high scrutiny” list and/or a “low scrutiny” list of message sources. If a message originates from a source on the high scrutiny list, such as a known bank or web service of a financial institution, the message may undergo special handling by the service 212, such as dividing an authentication code before delivering it.

In another embodiment, the filtering logic 306 includes content analysis capabilities to recognize the nature of the message content. For example, it can scan for keywords, formats, or patterns indicating the message is likely an authentication code used for multi-factor authentication. The logic 306 may look for content markers like “code,” “PIN,” a string of digits, or other textual patterns commonly found in authentication messages. When the analysis indicates the message is used for authenticating users, the filtering logic 306 can invoke additional actions such as dividing the message, or portions of the message, such as an authentication code, into multiple portions before sending it on to the subscriber.

The unified communications service 212 also comprises threat detection logic 310. This logic 310 determines a threat score for individual subscribers to assess the likelihood of fraudulent activity related to SIM swapping. The threat logic 310 may generate threat scores in a few different ways according to various embodiments.

In one embodiment, the threat detection logic 310 evaluates the threat for subscribers who have messages flagged by the filtering logic 308 described above. For these subscribers with flagged messages, the threat logic 310 analyzes recent login events logged by component 304 to check for suspicious patterns. For example, it may compare the locations and timestamps of the most recent logins to determine if the user could feasibly travel between the login sites in the elapsed time. If not, this raises the threat score.

In another embodiment, the threat logic 310 proactively monitors and scores all subscribers, not just those with flagged messages. Here, the logic 310 periodically evaluates recent login data to detect anomalous patterns, such as logins from geographically disparate locations within a short time span. It may also maintain risk profiles for different geographic regions, where logins from high-risk areas increase the threat score by greater amounts. The threat logic 310 allows the service 212 to quantify the risk of SIM swapping for each subscriber. The threat score can then be used to determine whether to subject certain messages, like those with authentication codes, to additional processing such as splitting before delivery.

The unified communications service 212 also includes message handling logic 312. This component 312 facilitates the division of certain messages, such as those containing authentication codes, into multiple portions before delivering them. For example, when the threat level for a subscriber exceeds a threshold, the message handling logic 312 may intervene to divide an incoming SMS message with an authentication code into two pieces.

With some embodiments, the message handling logic 312 is configured to process multi-factor authentication (MFA) passcodes, which are commonly delivered via SMS. These passcodes are often 8-digit numerical codes generated for one-time use. The message filtering logic 306 recognizes when an incoming SMS contains an 8-digit MFA passcode. The message handling logic then divides this 8-digit code into two 4-digit portions. The message handling logic 312 sends the first 4-digit portion to the native SMS messaging application on the subscriber's mobile device, addressing it using the IMSI or other identifier associated with the SIM card. It sends the second 4-digit portion to the subscriber's unified communications messaging client, such as a chat application or email. In some cases, the 4-digit portion may be processed using text-to-speech, so that it can be played as an audio file and delivered over a telephone.

With some embodiments, the server may verify SMS messages before allowing them to be delivered to a user's mobile device. Specifically, when an SMS message is received that is addressed to a subscriber, the server will check if the destination mobile device is registered. If not, the server will block the SMS message from being delivered over the mobile network. Instead, the server will send a notification via the unicied communications client application to the user's registered client, indicating an SMS is waiting, and allow the user to download the SMS message through the client application interface once authenticated. This prevents unauthorized users who have SIM swapped a subscriber from directly receiving sensitive SMS messages.

To transmit the second portion, the message handling logic 312 interfaces with the communications orchestrator 314. This communications orchestrator 314 includes various channels like chat, voice, video, etc. The message handling logic 312 submits the second 4-digit portion to the orchestrator 314 for delivery, in some instances, via a specific channel, and in other instance, via a subscriber's preferred communications channel. In vet other instance, the message with the second portion of the code may be communicated to a client application at which the subscriber was last active. In this way, the full 8-digit MFA passcode is divided into two 4-digit pieces sent over separate channels.

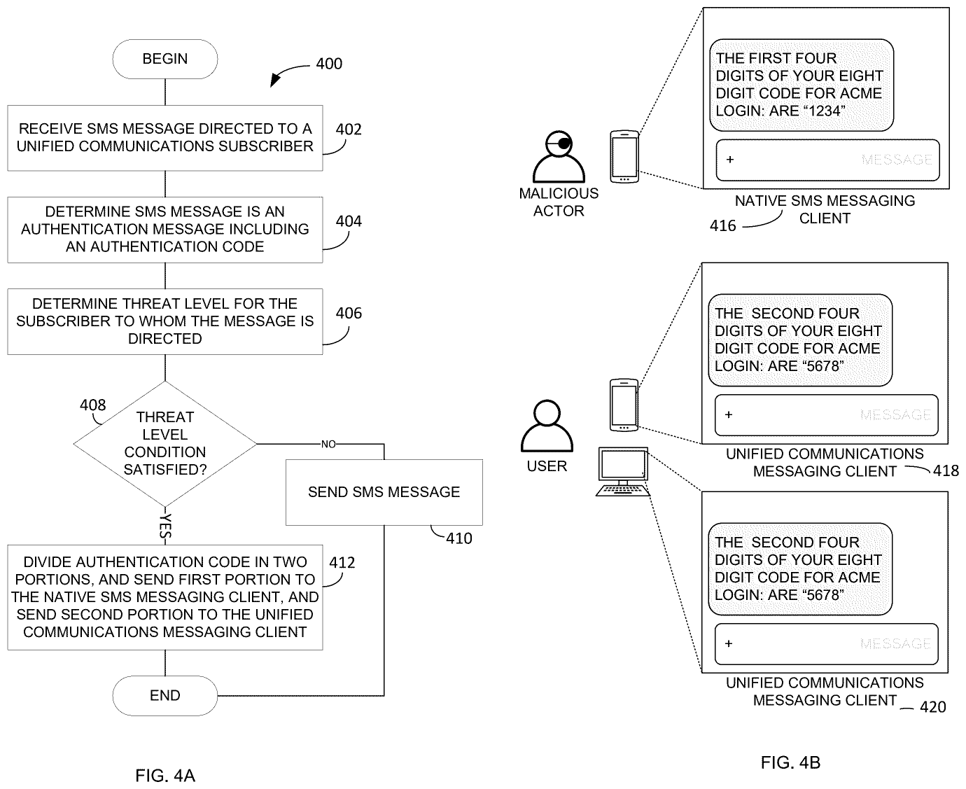

FIG. 4A is a diagram illustrating the method operations of a method 400, performed by one or more processors, or one or more servers of a unified communications service, to securely communicate an SMS message containing an authentication code, consistent with some embodiments. The method begins at operation 402 with the unified communications service receiving an SMS message that is addressed to a subscriber of the service. At operation 404, the service determines that the SMS message contains an authentication code, such as a multi-factor authentication passcode. At operation 406, the service determines a threat level for the subscriber to whom the message is directed, for example, by analyzing recent login events for suspicious patterns.

At step 408, the service checks if a threat condition is satisfied based on the determined threat level, for instance by comparing the threat level to a predetermined threshold. If the threat condition is not met, the method proceeds to operation 410 where the SMS message is sent normally without modification. However, if the threat condition is satisfied, the method advances to operation 412 where the authentication code in the SMS message is divided into two portions.

At operation 412, the service transmits the first portion of the authentication code to the native SMS messaging application on the subscriber's mobile device. At step 416, the service transmits the second portion of the authentication code to one or more unified communications messaging clients associated with the subscriber. The method then ends after the authentication code has been divided and delivered over two separate channels.

In situations where the subscriber's SIM card has not been compromised, the user will receive the two portions of the authentication code via two separate messaging channels. Specifically, the first portion will be received on the native SMS messaging application of the user's mobile device. The second portion will be received by the user via a unified communications messaging client. The user can then view the first portion received over SMS and the second portion received via the unified communications client app, and combine the two portions together to reconstruct the full authentication code. The user can then provide the complete code to the requesting service, such as by entering it on a website or providing it over a phone call, in order to authenticate their identity and complete the login or transaction. Because the user has access to both messaging channels and clients, they are able to reconstruct the full valid authentication code from the two portions.

In contrast, FIG. 4B illustrates what happens when a subscriber's SIM card has been compromised by a malicious actor through SIM swapping. In this case, the first portion of the authentication code is transmitted via regular SMS to the native messaging client application 416 of the compromised mobile device now controlled by the attacker. However, the second portion of the code is transmitted to the legitimate subscriber's unified communications messaging client 418 and 420. This is depicted in the user interface diagrams of FIG. 4B. The malicious actor in control of the subscriber's phone number will only receive the first portion of the code via SMS. Meanwhile, the legitimate subscriber will receive the second portion of the code via one or more unified communications client applications. Neither party receives the complete valid authentication code in this case. This allows the technique to detect and thwart unauthorized access attempts after SIM swapping.

### Machine and Software Architecture

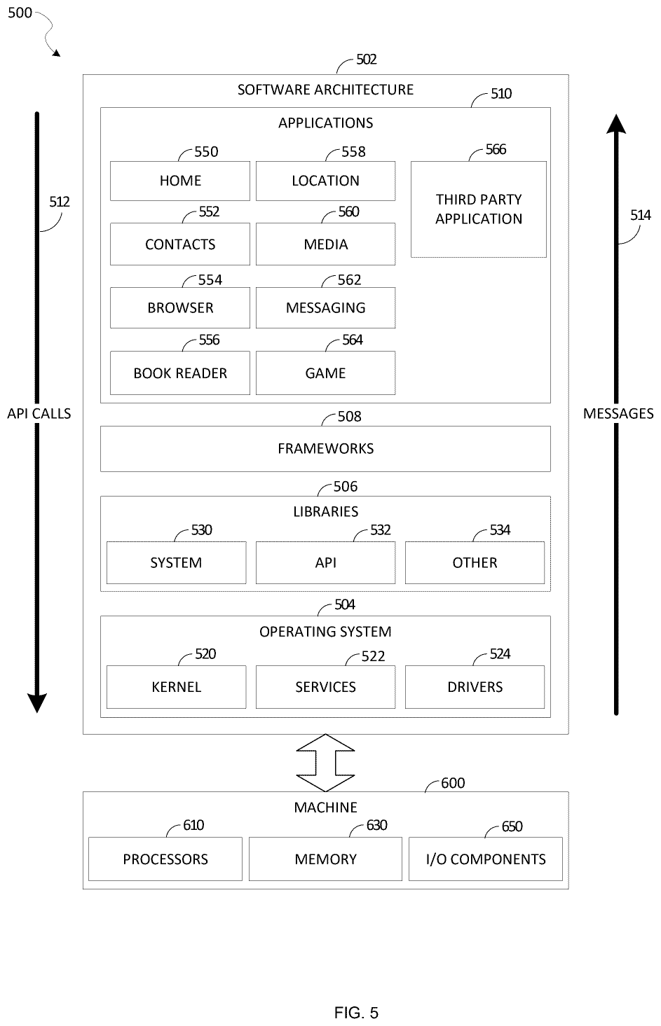

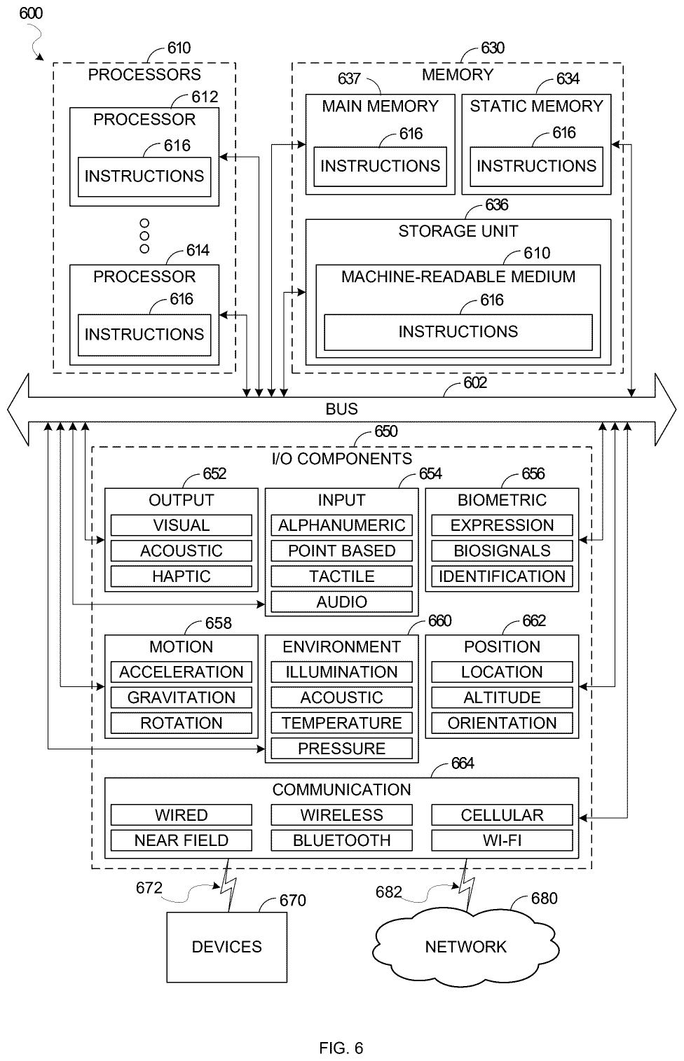

FIG. 5 is a block diagram 500 illustrating a software architecture 502, which can be installed on any of a variety of computing devices to perform methods consistent with those described herein. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 602 includes layers such as an operating system 504, libraries 506, frameworks 508, and applications 510. Operationally, the applications 510 invoke API calls 512 through the software stack and receive messages 514 in response to the API calls 512, consistent with some embodiments.

In various embodiments, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also include a wide variety of other libraries 634 to provide many other APIs to the applications 510.

The frameworks 508 provide a high-level common infrastructure that can be utilized by the applications 510, according to some embodiments. For example, the frameworks 508 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 610, structured in a variety of manners, such as object-oriented programming languages (e.g., Objective-C. Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone. or another mobile operating system. In this example, the third-party application 666 can invoke the API calls 512 provided by the operating system 504 to facilitate functionality described herein.

FIG. 6 illustrates a diagrammatic representation of a machine 600 in the form of a computer system within which a set of instructions may be executed for causing the machine to perform any one or more of the methodologies discussed herein, according to an example embodiment. Specifically. FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example the instructions 616 may cause the machine 600 to execute any one of the methods or algorithmic techniques described herein. Additionally, or alternatively, the instructions 616 may implement any one of the systems described herein. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 916 to perform any one or more of the methodologies discussed herein.

The machine 600 may include processors 610, memory 630, and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions contemporaneously. Although FIG. 6 shows multiple processors 610, the machine 600 may include a single processor with a single core, a single processor with multiple cores (e.g., a multi-core processor), multiple processors with a single core, multiple processors with multiples cores, or any combination thereof.

The memory 630 may include a main memory 632, a static memory 634, and a storage unit 636, all accessible to the processors 610 such as via the bus 602. The main memory 630, the static memory 634, and storage unit 636 store the instructions 616 embodying any one or more of the methodologies or functions described herein. The instructions 916 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical key board, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 630, 632, 634, and/or memory of the processor(s) 610) and/or storage unit 636 may store one or more sets of instructions and data structures (e.g., software) embodying or utilized by any one or more of the methodologies or functions described herein. These instructions (e.g., the instructions 616), when executed by processor(s) 610, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices: magnetic disks such as internal hard disks and removable disks: magneto-optical disks; and CD-ROM and DVD-ROM disks. The terms “machine-storage media.” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 680 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi®; network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (IxRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method for securing a two-factor authentication against subscriber identity module (SIM) hijacking, the method comprising:
receiving, by a server computer providing a communications service, a first short message service (SMS) message addressed to a subscriber of a mobile network service;
determining, by the server computer, that the first SMS message comprises an authentication code for use in accessing a web service;
dividing, by the server computer, the authentication code into a first portion and a second portion;
transmitting, by the server computer, a second SMS message comprising the first portion of the authentication code to a native messaging application executing on a mobile device associated with the subscriber, using as an address a unique identifier associated with a subscriber identity module (SIM) of the mobile device; and
transmitting, by the server computer, a message comprising the second portion of the authentication code to one or more unified communications messaging clients associated with the subscriber;
wherein the first portion of the authentication code and the second portion of the authentication code are to be provided together for use in accessing the web service.

2. The method of claim 1, further comprising:
determining, by the server computer, a threat score for the subscriber, based on locations associated with recent logins by the subscriber to the unified communications service; and
comparing, by the server computer, the threat score to a threshold;
wherein dividing the authentication code into the first portion and the second portion occurs responsive to determining that the threat score transgresses the threshold.

3. The method of claim 2, wherein determining the threat score comprises:
identifying, from the locations associated with the recent logins by the subscriber, a first login at a first location and time;
identifying, from the locations associated with the recent logins by the subscriber, a second login at a second location and time, wherein the second time is within a specified time period of the first time;
determining a distance between the first location and the second location;
determining, based on the distance and the specified time period, that the distance for the specified time period exceeds a threshold, indicating it would be impractical for the subscriber to physically move from the first location to the second location within the specified time period; and
responsive to determining that it would be impractical to move between the first and second locations within the specified time period, increasing the threat score.

4. The method of claim 2, wherein determining the threat score further comprises:
accessing, by the server computer, a data store indicating location risk scores for a plurality of geographic locations, wherein the location risk scores are based on histories of fraudulent activity associated with the geographic locations;
identifying, from the locations associated with the recent logins by the subscriber, a first login at a first geographic location;
determining a first location risk score associated with the first geographic location; and
increasing the threat score by an amount based on the first location risk score.

5. The method of claim 1, further comprising:
accessing, by the server computer, a data store comprising device registration records indicating associations between subscribers of the unified communications service and unique identifiers of subscriber identity modules (SIMs); and
determining, by the server computer, based on the data store, that the unique identifier associated with the SIM of the mobile device is registered as being associated with the subscriber;
wherein transmitting the second SMS message occurs responsive to determining that the unique identifier is registered as being associated with the subscriber

6. The method of claim 1, wherein the authentication code in the first SMS message is an eight character one-time passcode for use in logging into a website, the method further comprising:
dividing the eight character passcode into a first portion having a length of four characters, and a second portion having a length of four characters.

7. The method of claim 1, further comprising:
determining, by the server computer, which of the one or more unified communications messaging clients associated with the subscriber was most recently actively used by the subscriber;
wherein transmitting the message comprising the second portion of the authentication code comprises transmitting the message to the unified communications messaging client determined to have been most recently actively used by the subscriber.

8. The method of claim 1, further comprising:
monitoring, by the server computer, a status of the native messaging application on the mobile device;
determining, based on the monitoring, that the native messaging application is non-functional; and
responsive to determining that the native messaging application is non-functional, transmitting a notification to the one or more unified communications messaging clients indicating suspected fraudulent activity.

9. A system for securing a two-factor authentication against subscriber identity module (SIM) hijacking, the system comprising:
one or more processors;
a memory storing instructions that, when executed by the one or more processors, cause the system to:
receive, by a server computer providing a communications service, a first short message service (SMS) message addressed to a subscriber of a mobile network service;
determine, by the server computer, that the first SMS message comprises an authentication code for use in accessing a web service;
divide, by the server computer, the authentication code into a first portion and a second portion;
transmit, by the server computer, a second SMS message comprising the first portion of the authentication code to a native messaging application executing on a mobile device associated with the subscriber, using as an address a unique identifier associated with a subscriber identity module (SIM) of the mobile device; and
transmit, by the server computer, a message comprising the second portion of the authentication code to one or more unified communications messaging clients associated with the subscriber;
wherein the first portion of the authentication code and the second portion of the authentication code are to be provided together for use in accessing the web service.

10. The system of claim 9, wherein the memory stores additional instructions that, when executed by the one or more processors, cause the system to:
determine a threat score for the subscriber, based on locations associated with recent logins by the subscriber to the unified communications service;
compare the threat score to a threshold; and
divide the authentication code into the first portion and the second portion responsive to determining that the threat score transgresses the threshold.

11. The system of claim 10, wherein to determine the threat score, the memory stores additional instructions that, when executed by the one or more processors, cause the system to:
identify, from the locations associated with the recent logins by the subscriber, a first login at a first location and time;
identify, from the locations associated with the recent logins by the subscriber, a second login at a second location and time, wherein the second time is within a specified time period of the first time;
determine a distance between the first location and the second location;
determine, based on the distance and the specified time period, that the distance for the specified time period exceeds a threshold, indicating it would be impractical for the subscriber to physically move from the first location to the second location within the specified time period; and
responsive to determining that it would be impractical to move between the first and second locations within the specified time period, increase the threat score.

12. The system of claim 10, wherein to determine the threat score, the memory stores additional instructions that, when executed by the one or more processors, cause the system to:
access a data store indicating location risk scores for a plurality of geographic locations, wherein the location risk scores are based on histories of fraudulent activity associated with the geographic locations;
identify, from the locations associated with the recent logins by the subscriber, a first login at a first geographic location;
determine a first location risk score associated with the first geographic location; and
increase the threat score by an amount based on the first location risk score.

13. The system of claim 9, wherein the memory stores additional instructions that, when executed by the one or more processors, cause the system to:
access a data store comprising device registration records indicating associations between subscribers of the unified communications service and unique identifiers of subscriber identity modules (SIMs);
determine, based on the data store, that the unique identifier associated with the SIM of the mobile device is registered as being associated with the subscriber; and
transmit the second SMS message responsive to determining that the unique identifier is registered as being associated with the subscriber.

14. The system of claim 9, wherein the authentication code in the first SMS message is an eight character one-time passcode for use in logging into a website, and wherein the memory stores additional instructions that, when executed by the one or more processors, cause the system to:
divide the eight character passcode into a first portion having a length of four characters, and a second portion having a length of four characters.

15. The system of claim 9, wherein the memory stores additional instructions that, when executed by the one or more processors, cause the system to:
determine which of the one or more unified communications messaging clients associated with the subscriber was most recently actively used by the subscriber; and
transmit the message comprising the second portion of the authentication code by transmitting the message to the unified communications messaging client determined to have been most recently actively used by the subscriber.

16. The system of claim 9, wherein the memory stores additional instructions that, when executed by the one or more processors, cause the system to:
monitor a status of the native messaging application on the mobile device;
determine, based on the monitoring, that the native messaging application is non-functional; and
responsive to determining that the native messaging application is non-functional, transmit a notification to the one or more unified communications messaging clients indicating suspected fraudulent activity.

17. A non-transitory computer-readable medium storing instructions that, when executed by one or more processors, cause the one or more processors to perform steps for securing a two-factor authentication against subscriber identity module (SIM) hijacking, the steps comprising:
receiving a first short message service (SMS) message addressed to a subscriber of a mobile network service;
determining that the first SMS message comprises an authentication code;
dividing the authentication code into a first portion and a second portion;
transmitting a second SMS message comprising the first portion of the authentication code to a native messaging application executing on a mobile device associated with the subscriber, using as an address a unique identifier associated with a subscriber identity module (SIM) of the mobile device; and
transmitting a message comprising the second portion of the authentication code to one or more unified communications messaging clients associated with the subscriber.

18. The non-transitory computer-readable medium of claim 17, wherein the steps further comprise:
determining a threat score for the subscriber, based on locations associated with recent logins by the subscriber to the unified communications service;
comparing the threat score to a threshold; and
dividing the authentication code into the first portion and the second portion responsive to determining that the threat score transgresses the threshold.

19. The non-transitory computer-readable medium of claim 18, wherein determining the threat score comprises:
identifying, from the locations associated with the recent logins by the subscriber, a first login at a first location and time;
identifying, from the locations associated with the recent logins by the subscriber, a second login at a second location and time, wherein the second time is within a specified time period of the first time;
determining a distance between the first location and the second location;
determining, based on the distance and the specified time period, that the distance for the specified time period exceeds a threshold, indicating it would be impractical for the subscriber to physically move from the first location to the second location within the specified time period; and
responsive to determining that it would be impractical to move between the first and second locations within the specified time period, increasing the threat score.

20. The non-transitory computer-readable medium of claim 18, wherein determining the threat score further comprises:
accessing a data store indicating location risk scores for a plurality of geographic locations, wherein the location risk scores are based on histories of fraudulent activity associated with the geographic locations;
identifying, from the locations associated with the recent logins by the subscriber, a first login at a first geographic location;
determining a first location risk score associated with the first geographic location; and
increasing the threat score by an amount based on the first location risk score.
